(19) United States
(12) Patent Application Publication
(10) Pub. No.: US 2023/0052131 A1
(43) Pub. Date: Feb. 16, 2023

(54) System and Method for Distributed Data Processing

(71) Applicant: Edge Al, LLC, Jacksonville, FL (US)

(72) Inventor: Michael C. Pinkus, Cumming, GA (US)

(21) Appl. No.: 17/399,788

(22) Filed: Aug. 11, 2021

(51) Int. Cl. G06N 3/04; G06N 3/063; G06F 9/38; G06F 1/20; H04W 4/40

(52) U.S. Cl. CPC G06N 3/04; G06N 3/063; G06F 9/3877; G06F 1/206; H04W 4/40

(57) ABSTRACT

A distributed data processing system includes a processing center or algorithm persistence system (“APS”), a series of remote caching nodes in electronic communication with the APS, and a series of remote computing or processing nodes in electronic communication with the remote caching nodes. Each remote caching node is mounted to a top surface of a mobile vehicle and includes a data transmitter/receiver (transceiver), computer hardware and software to operate the caching node, memory to transmit or transfer data from the APS to the remote processing nodes. The remote processing nodes include a series of electricity generating solar panels, a series of electronic data processing chips, electronic data memory, an electronic date transmitter/receiver (transceiver), and a motion sensor. The series of electronic data processing chips are preferably a tensor processing unit (TPU), which is an AI accelerator application-specific integrated circuit (ASIC) developed specifically for neural network machine learning.

### STATEMENT REGARDING FEDERALLY SPONSORED RESEARCH OR DEVELOPMENT

Not applicable.

### CROSS REFERENCE TO RELATED APPLICATIONS

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### FIELD OF THE INVENTION

The present inventive concept relates to the field of data processing. More particularly, the invention relates to a system and method of data processing in a distributed manner.

### TECHNOLOGY IN THE FIELD OF THE INVENTION

Data processing is typically conducted using a computer system to process the data and provide the results. Some data processing applications today require huge processing capabilities that consume extremely large quantities of power. These large processing application may also utilize large amounts of bandwidth when the data must be transmitted continuously over a network such as the internet.

In an effort to offset energy costs and environmental concerns, large solar energy farms are being implemented to supply “green” electricity. However, the production of solar energy at a remote location is not efficient, as the solar electricity must be converted to a.c. current, transferred over power lines to a consumed location, and then converted back to d.c. current for use in the computer systems processing the data. The conversion of d.c. current to a.c. current results in an approximately 15% loss of electricity. Similarly, the conversion of a.c. current to d.c. current again results in an approximately 15% loss of electricity. The internal resistance of the transport power lines depends on the distance traveled, but may also consume approximately 10% of the electricity. Thus, the generation of electric power at a solar electricity farm and the transportation of that electricity to another location for consumption in data processing results in large quantities of electricity being lost or wasted.

A problem associated with large solar electric farms is the costs of acquiring or leasing the land, as large solar electric farms may require hundreds of acres of land. The costs of the structures or infrastructure used to mount the solar panels of these solar electric farms to the ground and the equipment used to convert the d.c. power generated by such solar panels to a.c. power for transportation is very large. Additionally, there are many rules, regulations or laws concerning the use of land, environmental impact studies for the land use, and the operation of these solar electric farms. The abidance to these regulations and requirements also increases the cost associated with such solar electric farms.

Another problem associated with the large data processing of large amounts of data is that the computer processing creates a large amount of heat. Thus, a computer system contained within a building must be cooled to run efficiently. This cooling also consumes large amounts of electricity.

The use and storage of large quantities of data may use cloud computing, which is a more recent development wherein cloud services are centralized in a vendor-managed “cloud” (collection of data centers) that can be accessed from a device over the internet. However, cloud computing can introduce latency because of the distance between users and the data centers where cloud services are hosted. Again, these transfers of data consume large quantities of electricity.

In an effort to reduce latency associated with the distance between the user and the data centers, developers have developed “edge computing” paradigm that brings computation and data storage closer to the source of the data. This is supposed to improve response times and save bandwidth. With edge computing, the data processing may occur at the same location as the data being inputted for processing. For example, instead of a picture being taking for facial recognition being taken at a location and then digitally transferred to a remote data processing center for processing the facial recognition algorithm and then being sent back to the user at the location of the camera, the camera itself would include all the processing capabilities to take the picture, process the picture through the facial recognition algorithm, and provide the resulting data. This greatly reduces the need to transmit the data and greatly reduces the power consumption associated with such. However, this still utilizes a centralized municipal power source to operate.

Accordingly, a need exists for a data processing system that reduces the cost of electricity associated with the processing of large quantities of data. It is to the provision of such therefore that the present invention is primarily directed.

### BRIEF SUMMARY OF THE INVENTION

A distributed data processing system comprises a solar panel, a series of electronic data processing chips electronically coupled to the solar panel, computer memory coupled to the series of electronic data processing chips, a wireless transceiver electronically coupled to the series of electronic data processing chips, and a mobile vehicle having a top surface. The solar panel is mounted to the top surface of the mobile vehicle.

A distributed data processing system comprises a processing center, a plurality of remote caching nodes in electronic communication with the processing center, a plurality of remote processing nodes capable of being in electronic communication with the remote caching nodes, and a plurality of mobile vehicles wherein each mobile vehicle has a top surface, wherein each remote processing node of the plurality of remote processing nodes is coupled the top surface of one mobile vehicle of the plurality of mobile vehicles.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a schematic view of a distributed data processing system embodying principles of the invention in a preferred form.

FIG. 2 is a schematic view of a remote processing node of the distributed data processing system of FIG. 1.

FIG. 3 is a schematic view of a housing for the distributed data processing system of FIG. 1.

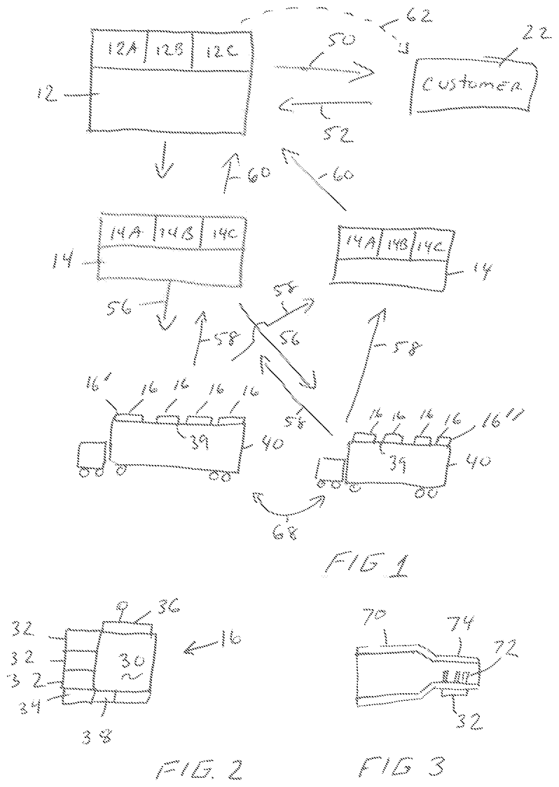

### DETAILED DESCRIPTION OF CERTAIN EMBODIMENTS

### Definitions

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

### Description of Selected Specific Embodiments

With reference next to the drawings, there is a shown a distributed data processing system 10 in a preferred form of the present invention, referenced hereinafter simply as processing system 10. The processing system 10 includes a processing center or algorithm persistence system (“APS”) 12, a series or plurality of remote caching nodes 14 in electronic communication with the APS 12, and a plurality or series of remote computing or processing nodes 16, which are shown as a first remote processing node 16′ and a second remote processing node 16″, in electronic communication with the remote caching nodes 14. The APS 12 is in electronic communication with data providers or customers 22.

The APS 12 includes all the components necessary to receive and transmit data including a data transmitter and receiver 12A (transceiver), computer servers and the software associated 12B with such, and computer memory 12C necessary to store the transferred data. Additionally, the APS 12 includes all the conventional cloud computing software necessary to manipulate or process the data, that may also be transferred to the remote processing nodes 16. The APS server may be a STM32WB3OCEUSA by STMicroelectronics or PowerEdge R450 server by Dell Technologies.

The remote caching node 14 includes a data transmitter/receiver 14A (transceiver), computer hardware and software 14B to operate the caching node 14, computer memory 14C to store the data. The transceiver may be a MAX2851ITK+ made by Maxim Integrated Products, Inc., a BMD-330-A-R Bluetooth transceiver by U-blox American, Inc., or a BCM4360KMLG by Broadcom Limited. The computer memory may be an EMMC128-TX29-8ACOI by Kingston Technology Corporation. The CPU may be a MIMXRT1052 CVL5B by NXP USA, Inc or a STM32WB3OCEUSA by STMicroelectronics or PowerEdge R450 server by Dell Technologies. The remote caching node 14 is preferably located at a designated stopping point for a vehicle 40 associated with the remote processing node 16, such as a designated truck stop or hub, warehouse, merchandise transfer depot or hub, train station, airport, gas station, weigh station, or the like, hereinafter referenced collectively as transportation transient hub.

The remote processing nodes 16 include a series of electricity generating solar panels 30 wherein each solar panel 30 is coupled to a series of electronic data processing chips 32, electronic data memory 34 coupled to the series of electronic data processing chips 32, an electronic date transmitter/receiver (transceiver) 36, and a motion sensor 38. The solar panel 30 may be a flexible solar panel that is mountable, such as with an adhesive, to an underlying surface. The transceiver may be a MAX2851ITK+ made by Maxim Integrated Products, Inc., a BMD-330-A-R Bluetooth transceiver by U-blox American, Inc., or a BCM4360KMLG by Broadcom Limited. The computer memory may be an EMMC128-TX29-8ACOI by Kingston Technology Corporation. The CPU may be a MIMXRT1052 CVL5B by NXP USA, Inc or a STM32WB3OCEUSA by STMicroelectronics or PowerEdge R450 server by Dell Technologies. The TPU may be a Hailo-8 AI Processor by Hailo Enpowering Intelligence, a NDP120 Neural Precision Processor by Syntiant Corp., or a Coral Accelerator Module Edge TPU by Google, LLC. The solar panel may be a Renogy 100w by Renogy, a Top Solar flexible solar panel by Top Solar Energy, or a SunPower solar panel by Sun Power Corporation or Maxeon Solar Technologies. The series of electronic data processing chips 32 are preferably tensor processing units (TPU), which is an AI accelerator application-specific integrated circuit (ASIC) developed specifically for neural network machine learning. Tensor processing units are also one kind of electronic data processing chip which is a machine learning inference processing units. As an alternative to the solar panels 30, the vehicle may alternatively be adapted to include other types of vehicle energy conversion systems, such as regenerative axle energy harvesting systems, brake energy harvesting systems, magneto restrictive vibration energy harvesting systems, or the like.

The data processing chips 32 may also be any cpu, gpu, machine learning asic's, cryptocurrency asic's, field programmable gate arrays, or other integrated circuits or system of chips and various algorithms and code logic executing on them. The motion sensor 38 may be a GPS chip or unit, an accelerometer, or other device which senses the movement of the vehicle or trailer.

The remote processing nodes 16 operate independently from any power or electricity being provided by the associated vehicle 40.

The remote processing node 16 is mounted to the top surface 39 of a mobile vehicle 40. The vehicle 40 is preferably a semi-truck trailer that provides a large, flat top surface 39 area upon which to mount the solar panels 30. However, the vehicle may be any transportation means, such as a train, bus, automobile, airplane, etc.

In use, upon the request by a customer 22, the APS 12 establishes an account with the customer by instituting an identity and customer unique identifier such as an account number using a cryptography management system that is assigned or self-assigned to one or more identity credentials, such as a username and password.

The customer possesses customer acquired data or dataset that is to be processed using select processing rules or algorithms that is in the form of a meta dataset. The acquired dataset may be from one or more acquisition devices, such as, but not limited to, cameras, weather sensors, measurement means, facial recognition, or any other device that acquires data from processing. As such, the dataset may be a video file, image file, text file, audio file or byte stream, or any other file formats or contents. The “processing rules” may be one or more algorithms or rules informing the manner in which the acquired dataset is to be processed, for example, facial recognition software, motion realization software, or the like. The acquired dataset and processing rules (meta dataset) are combined to create a data file or payload.

To process a large customer acquired dataset, the APS 12 utilizes the cryptography management system that generates both symmetric and asymmetric key (private cryptographic and public cryptographic key) generation means to electronically transmits through the transceiver 12A a public encryption or cryptographic key to the data provider or customer 22, shown at arrow 50. The customer 22 receives and utilizes the public cryptography key to encrypt the submitted or acquired dataset to be processed and electronically transmits the encrypted acquired dataset and the processing rules/meta dataset, together referenced herein as the payload, to the APS 12 for processing, shown at arrow 52. The cryptography management system stores the public and private cryptographic key within the cryptography management system in memory 12C. The payload is transferred from the customer 22 to the transceiver 12A of the APS 12 using a customer interface, which may use a web api, tcp connection, udp connection, or any other digital transport mechanism.

The payload containing the encrypted acquired dataset and rules data (meta dataset) is then transmitted from the transceiver 12A of the APS 12 to the transceiver 14A of the remote caching node 14, as shown by arrow 54. The APS 12 also transmits the cryptographic private key to the remote caching node 14.

In turn, the remote caching node 14 causes the payload and cryptographic private key to be transmitted from the transceiver 14A of the remote caching node 14 to the transceiver 36 of one of the remote processing nodes 16, as shown by arrows 56. The APS 12 determines which remote processing node 16 is provided or assigned the data processing task depending on various criteria, such as the estimated time the vehicle 40 carrying the remote processing node 16 is intended to be at the location associated with the remote caching node 14 (the transportation transient hub), the amount of data within the payload, etc. Some factors may be assisted by the motion sensor 38 that can help determine the status and likely duration a vehicle may be at a certain location. It should also be understood that the acquired dataset from the customer 22 may be broken down into portions or segments of datasets so that its processing may occur over more than one remote processing node 16, thus the use of the term distributed data processing.

Once the payload has been received by the remote processing node 16, the manipulation or processing of the acquired dataset may proceed according to the processing rules or meta dataset also contained in the payload. This processing of data may occur as the vehicle 40 is stationary at the transportation transient hub/remote caching node 14 location, or while the vehicle 40 is moving or in route.

The acquired dataset is processed by the electronic data processing chips 32 of the remote processing node 16 using the cryptographic private key to produce a data result set. The power utilized to operate the electronic data processing chips 32 is provided by the solar panel(s) 30 coupled to the electronic data processing chips. The data result set generated by the processing may be temporarily stored within the electronic data memory 34.

Once the vehicle 40 returns to a transportation transient hub the remote caching node 14 at that location causes the data result set to be transferred through the transceiver 36 of the remote processing node 16 to the transceiver 14A of the remote caching node 14, as shown by arrows 58 The transportation transient hub and associated remote caching node 14 may be the same or different from the original transportation transient hub and associated remote caching node 14 wherein the payload was originally downloaded, as the vehicle may drive to a different location or may drive and return to the same location. Also, the processing may occur while the vehicle is not in motion.

The remote caching node 14 then causes the data result set to be transferred through the transceiver 14A of the remote caching node to the transceiver 12A of the APS 12, as shown by arrows 60.

Lastly, the data result set is transferred through the transceiver 12A of the APS 12 to the transceiver of the customer 22, as shown by arrow 62. These transceivers may be hard wired or be wireless.

As such, the distributed data processing system comprises a solar panel, a series of electronic data processing chips electronically coupled to the solar panel, computer memory coupled to the series of electronic data processing chips, a wireless transceiver electronically coupled to the series of electronic data processing chips, and a mobile vehicle having a top surface. The solar panel 30 is mounted to the top surface of the mobile vehicle while the processing chips 32, transceiver 36, memory 34, or sensor 38 may be mounted to the cab.

The distributed data processing system also comprises a processing center, a plurality of remote caching nodes in electronic communication with the processing center, a plurality of remote processing nodes capable of being in electronic communication with the remote caching nodes, and a plurality of mobile vehicles wherein each mobile vehicle has a top surface, wherein each remote processing node of the plurality of remote processing nodes is coupled the top surface of one mobile vehicle of the plurality of mobile vehicles.

It should be understood that the remote processing nodes 14 may also communicate between each other. The ability to communicate between remote processing nodes 14 allows for the payload, or a portion of the payload, to be transferred between remote processing nodes 14 so that each node may process a portion of the dataset or payload, as indicated by arrow 68. This option allows for the dataset to continue being processed even though a solar panel 39 may be running low on power, if a dataset cannot be processed before the vehicle returns to the location of the remote caching node 14, or other circumstance wherein the entire dataset is not processed completely.

It should also be understood that the components of the remote processing node 16 may be separated between the trailer and the cab of the tractor trailer truck. For example, the solar panels 39 may be mounted on the top of the trailer while the processing chips 30

It should be understood that by utilizing a vehicle, and preferably a moving vehicle, the heat generated by the data processing is dissipated or released into the ambient environment surrounding the vehicle, rather than being contained within a building which then requires power to operate a cooling system for the building. The use of the GPS or accelerometer aids in determining if a vehicle is moving or not, the time since last movement of the vehicle, or the like, to aid in determining which vehicle and associated remote processing node 16 is to be provided with the data to be processed. For the goal is to allow enough time to download the data to the remote processing node 16 without interruption. To aid or improve airflow over or about the data processing chips, the vehicle may be provided with air deflectors, shrouds, or housing which direct the air through a tunnel or ducting. This housing may also include a venturi tube 70 wherein cooling vanes or fins 7 associated with or coupled to the data processing chips 32 are mounted in the low pressure region 74 of the venturi tube to promote a cooling effect and dissipate heat more efficiently, as shown schematically in FIG. 3.

It should also be understood that utilizing solar panels mounted to a vehicle, rather than land, results in eliminating land use regulations, rules or laws, and avoids environmental impact studies associated with such. The elimination of the rules greatly reduces the costs involved in operating and powering the data processing process.

It should also be understood that the use of trucks, rather than static or stationary solar panels associated with electric solar farms, results in the remote processing node 16 being able to be located or moved relatively close to the remote caching node 14. This small distance of data travel aids in speeding the data transfer and reducing the power consumption associated therewith.

It should be understood that one vehicle may include multiple remote processing nodes. Similarly, one geographic location may include multiple remote caching nodes.

All references to transceivers and the transfer of data is understood to use any commonly available wireless network infrastructure, such as a LAN, Wi-Fi, internet, Bluetooth, or other protocol. In some instances, a hard wire may also be utilized rather than a wireless network. All these forms of data transfer or transmission may be referenced herein as data communicable between nodes or devices.

It will be appreciated that the inventions are susceptible to modification, variation and change without departing from the spirit thereof.

1. A distributed data processing system comprising:
a solar panel;
a series of electronic data processing chips electronically coupled to said solar panel;
computer memory coupled to said series of electronic data processing chips;
a wireless transceiver electronically coupled to said series of electronic data processing chips, and
a mobile vehicle having a top surface, said solar panel being mounted to said top surface of said mobile vehicle.

2. The distributed data processing system of claim 1 wherein said series of electronic data processing chips are mounted to said mobile vehicle so as to allow heat generated by said series of electronic data processing chips to be released into the ambient environment surrounding said mobile vehicle.

3. The distributed data processing system of claim 1 wherein said series of electronic data processing chips is a series of tensor processing units.

4. The distributed data processing system of claim 1 wherein said series of electronic data processing chips is a series of machine learning inference processing units.

5. The distributed data processing system of claim 1 wherein said series of electronic data processing chips, said computer memory, and said wireless transceiver are mounted to said top surface of said mobile vehicle.

6. The distributed data processing system of claim 1 wherein said mobile vehicle top surface includes an air housing for directing an airflow, and wherein said series of electronic data processing chips are coupled to cooling fins positioned within said air housing.

7. The distributed data processing system of claim 6 wherein said air housing is a venturi tube, and wherein said cooling fins are mounted within a low pressure portion of said venturi tube.

8. A distributed data processing system comprising:
a processing center;
a plurality of remote caching nodes in electronic communication with said processing center;
a plurality of remote processing nodes capable of being in electronic communication with said remote caching nodes, and
a plurality of mobile vehicles, wherein each said mobile vehicle has a top surface and wherein each remote processing node of said plurality of remote processing nodes is coupled said top surface of one said mobile vehicle of said plurality of mobile vehicles.

9. The distributed data processing system of claim 8 wherein each remote processing node of said plurality of remote processing nodes includes a solar panel, a plurality of electronic data processing chips electronically coupled to said solar panel, computer memory coupled to said plurality of electronic data processing chips, and a wireless transceiver electronically coupled to said plurality of electronic data processing chips.

10. The distributed data processing system of claim 9 wherein said plurality of electronic data processing chips are mounted to said mobile vehicle so as to allow heat generated by said plurality of electronic data processing chips to be released into the ambient environment surrounding said mobile vehicle.

11. The distributed data processing system of claim 9 wherein said plurality of electronic data processing chips is a plurality of tensor processing units.

12. The distributed data processing system of claim 9 wherein said plurality of electronic data processing chips is a plurality of machine learning inference processing units.

13. The distributed data processing system of claim 9 wherein said plurality of remote caching nodes includes a wireless transceiver.

14. The distributed data processing system of claim 8 wherein said mobile vehicle top surface includes an air housing for directing an airflow, and wherein said plurality of electronic data processing chips are coupled to cooling fins positioned within said air housing.

15. The distributed data processing system of claim 14 wherein said air housing is a venturi tube, and wherein said cooling fins are mounted within a low pressure portion of said venturi tube.

16. A distributed data processing system comprising:
a processing center;
a plurality of remote caching nodes data communicable with said processing center;
a plurality of remote processing nodes wirelessly data communicable with said remote caching nodes, each remote processing node of said plurality of remote processing nodes including a vehicle energy conversion system and a plurality of processing chips powered by said vehicle energy conversion system, and
a plurality of mobile vehicles,
wherein each remote processing node of said plurality of remote processing nodes is coupled to one said mobile vehicle of said plurality of mobile vehicles.

17. The distributed data processing system of claim 16 wherein each remote processing node of said plurality of remote processing nodes also includes computer memory coupled to said plurality of electronic data processing chips, and a wireless transceiver electronically coupled to said plurality of electronic data processing chips.

18. The distributed data processing system of claim 16 wherein said plurality of electronic data processing chips are mounted to said mobile vehicle so as to allow heat generated by said plurality of electronic data processing chips to be released into the ambient environment surrounding said mobile vehicle.

19. The distributed data processing system of claim 16 wherein said plurality of electronic data processing chips is a plurality of tensor processing units.

20. The distributed data processing system of claim 16 wherein said plurality of electronic data processing chips is a plurality of machine learning inference processing units.

21. The distributed data processing system of claim 16 wherein said vehicle energy conversion system is at least one solar panel.

22. The distributed data processing system of claim 16 wherein each remote processing node of said plurality of remote processing nodes may transfer data to another remoted processing node of said plurality of remote processing nodes.
